(19) United States
(12) Patent Application Publication
(10) Pub. No.: US 2024/0350957 A1
(43) Pub. Date: Oct. 24, 2024

(54) HONEYCOMB FILTER

(71) Applicant: NGK INSULATORS, LTD., Nagoya-City (JP)

(72) Inventor: Yuki TAKAMURO, Himeji-Shi (JP)

(73) Assignee: NGK INSULATORS, LTD., Nagoya-City (JP)

(21) Appl. No.: 18/635,191

(22) Filed: Apr. 15, 2024

(51) Int. Cl. B01D 46/24

(52) U.S. Cl. CPC B01D 46/2482; B01D 46/24491; B01D 46/24492; B01D 46/2484

(57) ABSTRACT

A honeycomb filter includes a pillar-shaped honeycomb structure having a porous partition wall and a plugging portion, wherein a thickness of the partition wall is 152 to 254 μm, a cell density of the honeycomb structure is 38.8 to 62.0 cells/cm², a pore diameter D50 at which the cumulative pore volume is 50% of the total pore volume is 11 to 15 μm in a pore diameter distribution of the partition wall measured by the mercury press-in method, a porosity of the partition wall measured by the mercury press-in method is 60 to 75%, and a partition wall wet area ratio (A/S), which is a value obtained by dividing a wet area A of pores formed in the porous partition wall by a cross-sectional area S of the pores, is 0.21 to 0.35 m²/m².

The present application is an application based on Chinese Patent Application No. 202310433184.X filed on Apr. 21, 2023 with State Intellectual Property Office of the people's Republic of China, the entire contents of which are incorporated herein by reference.

### BACKGROUND OF THE INVENTION

### Field of the Invention

The present invention relates to a honeycomb filter. More specifically, the present invention relates to a honeycomb filter capable of improving purification performance while suppressing an increase in pressure loss.

### Description of the Related Art

As a means for reducing the emission of particulate matter contained in exhaust gas emitted from the internal combustion engine, there is known a method of providing a particulate filter designed to trap particulate matter by depositing it in the exhaust gas passage of the internal combustion engine (for example, Patent Document 1). In particular, in recent years, from the viewpoint of saving a mounting space, and the like, in order to simultaneously suppress emission of particulate matter and remove harmful components such as carbon monoxide (CO), hydrocarbons (HC), and nitrogen oxides (NOx), it has been studied to provide a catalyst layer by coating a catalyst slurry on a particulate filter and calcining the particulate filter.

As a particulate filter for exhaust gas purification, for example, a honeycomb filter using a honeycomb structure is known. The honeycomb structure includes a partition wall made of porous ceramics such as cordierite and a plurality of cells defined by the partition wall. In the honeycomb filter, plugging portions are provided in the honeycomb structure described above so as to plug open ends at the inflow end face side and open ends at the outflow end face side of the plurality of cells alternately.
[Patent Document 1] JP-A-2002-219319

In the honeycomb filter provided with a catalyst layer, in order to enhance exhaust gas purification performance by the catalyst, it is useful to increase the frequency of contact between the catalyst and exhaust gas by increasing a surface area of the porous partition wall on which the catalyst is loaded (in other words, the porous carrier). For example, one way to increase the surface area of the porous carrier constituting the partition wall is to increase a cell density of the honeycomb structure, but there is a problem in that increasing the cell density causes a significant increase in pressure loss. In particular, in a honeycomb filter represented by a gasoline particulate filter (GPF), there is a demand for developing a honeycomb filter capable of improving purification performance while suppressing an increase in pressure loss.

The present invention has been made in view of the problems with the prior arts described above. According to the present invention, there is provided a honeycomb filter capable of improving purification performance while suppressing an increase in pressure loss.

### SUMMARY OF THE INVENTION

According to the present invention, a honeycomb filter described below is provided.
[1] A honeycomb filter including: a pillar-shaped honeycomb structure having a porous partition wall disposed so as to surround a plurality of cells which serve as a fluid through channel extending from an inflow end face to an outflow end face; and
a plugging portion provided at either an end on the inflow end face side or an end on the outflow end face side of the cell; wherein
a thickness of the partition wall is 152 to 254 μm,
a cell density of the honeycomb structure is 38.8 to 62.0 cells/cm²,
a pore diameter D50 at which the cumulative pore volume is 50% of the total pore volume is 11 to 15 μm in a pore diameter distribution of the partition wall measured by the mercury press-in method,
a porosity of the partition wall measured by the mercury press-in method is 60 to 75%, and
a partition wall wet area ratio (A/S), which is a value obtained by dividing a wet area A of pores formed in the porous partition wall by a cross-sectional area S of the pores, is 0.21 to 0.35 m²/m².
[2] The honeycomb filter according to [1], wherein a pore diameter D10 at which the cumulative pore volume is 10% of the total pore volume is 5.5 to 7.5 μm in the pore diameter distribution of the partition wall measured by the mercury press-in method.
[3] The honeycomb filter according to [1] or [2], wherein a pore diameter D90 at which the cumulative pore volume is 90% of the total pore volume is 35.0 μm or less in the pore diameter distribution of the partition wall measured by the mercury press-in method.

The honeycomb filter of the present invention can improve purification performance while suppressing an increase in pressure loss. For example, when a catalyst layer is provided by coating a honeycomb filter with a catalyst slurry and firing the honeycomb filter, the catalyst slurry is applied so as to penetrate into the porous partition wall constituting the honeycomb structure. The partition wall wet area ratio (A/S) of the honeycomb filter of the present invention is set to 0.21 to 0.35 m²/m², so that the pores of relatively small diameter among the pores formed in the partition wall can be increased, and the surface area to which the catalyst is applied in the partition wall can be increased. Therefore, when the catalyst layer is provided in such a honeycomb filter, the frequency of contact between exhaust gas and the catalyst is increased, and purification performance by the honeycomb filter can be improved. Further, in the honeycomb filter of the present invention, the cell density of the honeycomb structure is set to 38.8 to 62.0 cells/cm², and purification performance can be improved as described above without excessively increasing the cell density. Therefore, purification performance of the honeycomb filter of the present invention can be more effectively improved while effectively suppressing an increase in pressure loss as compared with a conventional method in which purification performance is improved by increasing the cell density.

### BRIEF DESCRIPTION OF THE DRAWINGS

FIG. 1 is a perspective view schematically showing an embodiment of a honeycomb filter according to the present invention.

FIG. 2 is a plan view showing the inflow end face side of the honeycomb filter shown in FIG. 1.

FIG. 3 is a sectional view schematically showing a section taken along A-A′ of FIG. 2.

FIG. 4 is a conceptual diagram of the voxel data for determining the partition wall wet area ratio (A/S).

### DESCRIPTION OF THE PREFERRED EMBODIMENTS

The following will describe embodiments of the present invention; however, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter:

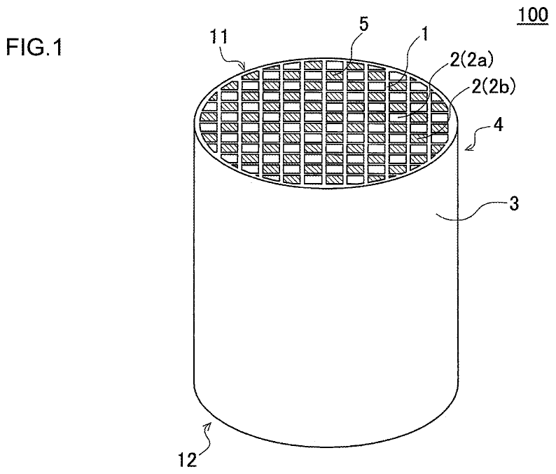

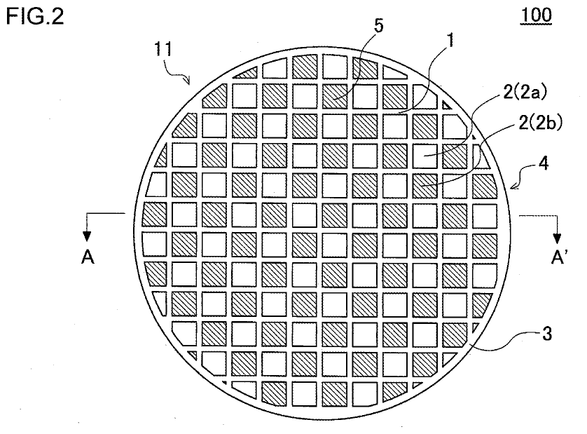

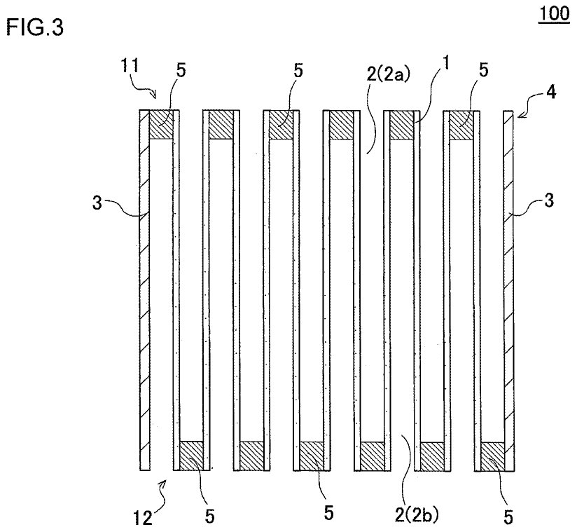

An embodiment of the honeycomb filter of the present invention is a honeycomb filter 100 as shown in FIGS. 1 to 3. Here, FIG. 1 is a perspective view schematically showing an embodiment of the honeycomb filter of the present invention. FIG. 2 is a plan view showing an inflow end face side of the honeycomb filter shown in FIG. 1. FIG. 3 is a sectional view schematically showing a section taken along A-A′ of FIG. 2.

As shown in FIGS. 1 to 3, the honeycomb filter 100 includes a honeycomb structure 4 and plugging portions 5. The honeycomb structure 4 is of pillar-shaped having a porous partition wall 1 disposed to surround a plurality of cells 2 which serve as a fluid through channel extending from an inflow end face 11 to an outflow end face 12. In the honeycomb filter 100, the honeycomb structure 4 has a pillar shape, and further includes a circumferential wall 3 at the outer peripheral side surface. In other words, the circumferential wall 3 is provided so as to encompass the partition wall 1 provided in a grid pattern.

The plugging portions 5 are disposed at open ends on the inflow end face 11 side or the outflow end face 12 side of each of the cells 2. In the honeycomb filter 100 shown in FIGS. 1 to 3, the plugging portions 5 are disposed at open ends at the ends on the inflow end face 11 side of the predetermined cells 2 and open ends at the ends on the outflow end face 12 side of the remaining cells 2, respectively. The cell 2 in which the plugging portion 5 is disposed at the open end on the outflow end face 12 side and the inflow end face 11 side is opened is defined as an inflow cell 2a. Further, the cells 2 in which the plugging portion 5 is disposed at the open end on the inflow end face 11 side and the outflow end face 12 side is opened is defined as an outflow cell 2b. The inflow cell 2a and the outflow cell 2b are preferably disposed alternately with the partition wall 1 therebetween. In addition, it is preferable that a checkerboard pattern is thereby formed by the plugging portions 5 and “the open ends of the cells 2” on both end faces of the honeycomb filter 100.

The honeycomb filter 100 has particularly major properties with respect to the configuration of the honeycomb structure 4 and the partition wall 1 constituting the honeycomb structure 4. That is, in the partition wall 1 constituting the honeycomb structure 4, a thickness of the partition wall 1 is 152 to 254 μm, a cell density of the honeycomb structure 4 is 38.8 to 62.0 cells/cm², a pore diameter D50 at which the cumulative pore volume is 50% of the total pore volume is 11 to 15 us in a pore diameter distribution of the partition wall 1 measured by the mercury press-in method, and a porosity of the partition wall 1 measured by the mercury press-in method is 60 to 75%. Further, a partition wall wet area ratio (A/S), which is a value obtained by dividing a wet area A of pores formed in the porous partition wall 1 by the cross-sectional area S of the pores, is 0.21 to 0 35 m²/m². Hereinafter, the fine pores formed in the porous partition wall 1 may be referred to as “pores” of the partition wall 1.

The honeycomb filter 100 configured as described above can improve purification performance while suppressing an increase in pressure loss. For example, when a catalyst layer is provided by coating a honeycomb filter 100 with a catalyst slurry and firing the honeycomb filter, the catalyst slurry is applied so as to penetrate into the porous partition wall 1 constituting the honeycomb structure 4. The partition wall wet area ratio (A/S) of the honeycomb filter 100 is set to 0.21 to 0 35 m²/m², so that the pores of relatively small diameter among the pores of the partition wall I can be increased, and the surface area to which the catalyst is applied can be increased. Therefore, when the catalyst layer is provided in the honeycomb filter 100, the frequency of contact between exhaust gas and the catalyst is increased, and purification performance by the honeycomb filter 100 can be improved. In the honeycomb filter 100, the cell density of the honeycomb structure 4 is set to 38.8 to 62.0 cells/cm², and purification performance can be improved without excessively increasing the cell density. Therefore, the honeycomb filter 100 can improve purification performance more effectively while effectively suppressing an increase in pressure loss as compared with a conventional method in which purification performance is improved by increasing the cell density. Hereinafter, the honeycomb filter 100 of the present embodiment will be described more specifically.

In the partition wall 1 constituting the honeycomb structure 4, a thickness of the partition wall 1 is 152 to 254 μm. By setting the thickness of the partition wall 1 to the above numerical range, it is possible to achieve both the securing of strength as a structure and the suppression of increase in pressure loss. For example, when the thickness of the partition wall 1 is less than 152 μm, it is not preferable in terms of strength degradation. When the thickness of the partition wall 1 exceeds 254 μm, pressure loss increases greatly, which is not preferable. Although not particularly limited, the thickness of the partition wall 1 is preferably 203 to 254 μm, and more preferably 203 to 229 μm. The thickness of the partition wall 1 can be measured with a scanning electron microscope or a microscope, for example.

In addition, in the honeycomb structure 4 having the partition wall 1 as described above, a cell density of the honeycomb structure 4 is 38.8 to 62.0 cells/cm². By setting the cell density to the above numerical range, it is possible to suppress an increase in pressure loss when ash deposites. For example, when the cell density is less than 38.8 cells/cm², a geometric surface area (GSA) is decreased, the thickness of the ash deposited layer is increased, and pressure loss is greatly increased, which is not preferable. When the cell density exceeds 62.0 cells/cm², the hydraulic diameter of gas inlet end face is reduced, and pressure loss is rapidly increased, which is not preferable. Although not particularly limited, the cell density of the honeycomb structure 4 is preferably 43 to 54 cells/cm², and more preferably 45 to 48 cells/cm².

In the partition wall 1, a pore diameter D50 at which the cumulative pore volume is 50% of the total pore volume is 11 to 15 μm in a pore diameter distribution of the partition wall 1 measured by the mercury press-in method. Hereinafter, in the pore diameter distribution of the partition wall 1, the pore diameter D50 at which the cumulative pore volume is 50% of the total pore volume may be simply referred to as “D50” in the pore diameter distribution of the partition wall 1. The “D50” is a value calculated by defining it as the pore diameter that gives half the volume of the total pore volume in the pore diameter distribution of the partition wall 1, and may also be referred to as an average pore diameter of the partition wall 1. When D50 is less than 11 μm, the pressure loss after the catalyst is applied may be drastically increased, which is not preferable. When the pore diameter D50 exceeds 15 μm, it is not preferable because the trapping performance deteriorates. Although not particularly limited, D50 is preferably 12 to 15 μm, and more preferably 13 to 15 μm.

The cumulative pore volume of the partition wall 1 is a value measured by a mercury press-in method. The cumulative pore volume of the partition wall 1 can be measured using, for example, Autopore 9500 (trade name) manufactured by Micromcritics. The measurement of the cumulative pore volume of the partition wall 1 can be performed by the following method. First, a part of the partition wall 1 is cut out from the honeycomb filter 100 to make a test piece for measuring the cumulative pore volume. The size of the test piece is not particularly limited, but the test piece is preferably, for example, a rectangular parallelepiped having a length, a width, and a height of approximately 10 mm, approximately 10 mm, and approximately 20 mm, respectively. The part of the partition wall 1 from which the test piece is cut out is not particularly limited, but the test piece is preferably made by cutting from the vicinity of the center in the axial direction of the honeycomb structure body. The obtained test piece is placed in a measurement cell of a measurement device, and the interior of the measurement cell is depressurized. Next, the mercury is introduced into the measurement cell. Next, the mercury introduced into the measurement cell is pressurized, and the volume of the mercury pushed into the pores existing in the test piece is measured during the pressurization. At this time, as the pressure applied to the mercury is increased, the mercury is pushed into the pores progressively from pores having a larger pore diameter and then to pores having a smaller pore diameter. Therefore, the relationship between the “pore diameter of the pores formed in the test piece” and the “cumulative pore volume” can be determined from the relationship between the “pressure applied to the mercury” and the “volume of the mercury pushed into the pores”. More specifically, as described above, when a pressure is gradually applied to the mercury in order to intrude into the pores of the sample (test piece) in a container sealed in a vacuum state by the mercury press-in method, the pressurized mercury intrudes into the larger pores and then into the smaller pores of the sample. Based on the pressure and the amount of mercury intruded at that time, the pore diameter and the pore volume of pores formed in the sample can be calculated. Hereinafter, when the pore diameters are denoted by D1, D2, D3 . . . , the relationship of D1>D2>D3 . . . is to be satisfied. In this case, the average pore diameter D between the respective measuring points (e.g., D1 to D2) can be indicated on the horizontal axis as “average pore diameter D=(D1+D2)/2.” Further, the Log differential pore volume on the vertical axis can be a value obtained by dividing an increment dV of the pore volume between the respective measuring points by a difference value treated as the logarithms of the pore diameter (i.e., “log (D1)-log (D2)”.

The porosity of the partition wall 1 measured by the mercury press-in method is 60 to 75%. When the porosity of the partition wall 1 is less than 60%, pressure loss when the catalyst is applied may increase drastically, which is not preferable. When the porosity of the partition wall 1 exceeds 75%, it is not preferable in terms of strength reduction. Although not particularly limited, the porosity of the partition wall 1 is preferably 61 to 70%, and more preferably 62 to 66%. The porosity of the partition wall 1 can be measured using, for example, Autopore 9500 (trade name) manufactured by Micromeritics. To measure the porosity, a part of the partition wall 1 is cut out from the honeycomb filter 100 to obtain a test piece, and the test piece thus obtained can be used.

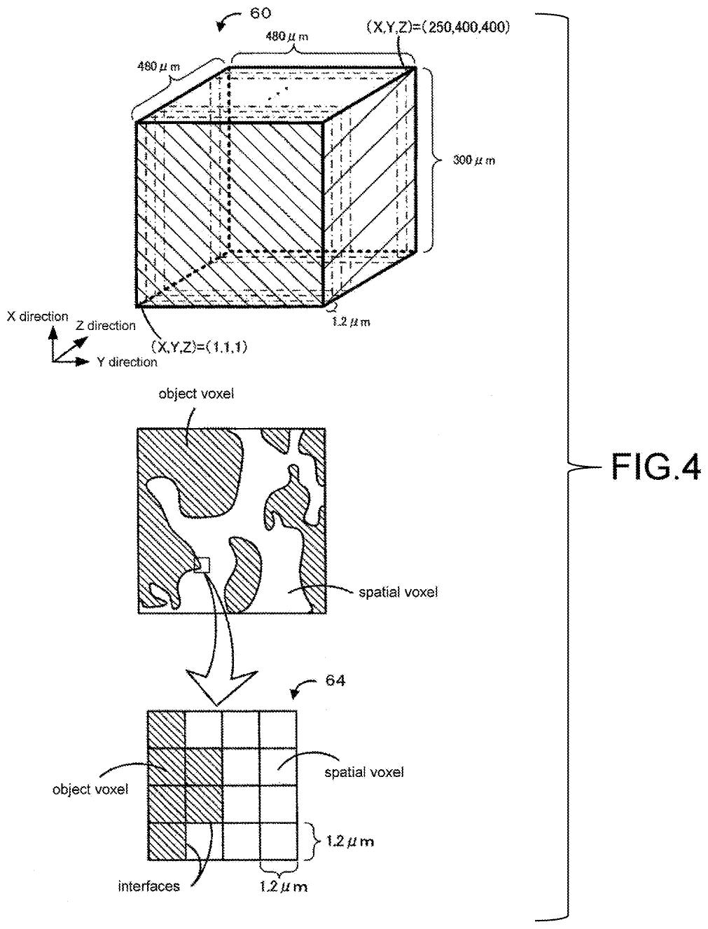

Further, the honeycomb filter 100 has a partition wall wet area ratio (A/S) of 0.21 to 0.35 m²/m², which will be described below. The partition wall wet area ratio (A/S) is a value (A/S) obtained by dividing a wet area A (m²) of pores formed in the porous partition wall 1 by a cross-sectional area S (m²) of the pores. The wet area A (m²) and the cross-sectional area S (m²) of the pores are calculated using three-dimensional voxel data 60 obtained by performing CT scanning on the partition wall 1. FIG. 4 is a conceptual diagram of the voxel data 60. First, a thickness direction of the partition wall 1 (for example, refer to FIG. 3) is taken as the X direction, an axial direction of the cell 2 (for example, a vertical direction in FIG. 3) is taken as the Y direction, and the XY plane is taken as an imaging cross section. Next, a plurality of image data are acquired by performing CT scanning of the partition wall 1 so as to capture a plurality of images by shifting the imaging cross section in the Z direction perpendicular to the XY direction, and voxel data 60 as shown in the upper part of FIG. 4 is obtained based on the image data. The resolution in each of the X, Y, and Z directions is 1.2 μm. The resulting cube of 1.2 μm on each side is the smallest unit of the three-dimensional voxel data 60, that is, the voxel. The image data of the imaging cross section obtained by CT scanning is a data of a plane having no thickness in the Z direction, but each imaging cross section is treated as having a thickness corresponding to the distance (1.2 μm) between the imaging cross sections in the Z direction. That is, each two-dimensional pixel of the image data is treated as a cube (voxel) having one side of 1.2 μm. As shown in the upper part of FIG. 3, the size of the voxel data 60 is a rectangular parallelepiped having 300 μm in the X direction (=1.2 μm×250 voxels), 480 μm in the Y direction (=1.2 μm×400 voxels), and 480 μm in the Z direction (=1.2 μm×400 voxels). The positions of the voxels are represented by X, Y, and Z coordinates (the coordinate value 1 corresponds to 1.2 μm, which is the length of one side of the voxel), and it is distinguished whether the voxel is a spatial voxel representing a space (pore) or an object voxel representing an object. The distinction between the spatial voxel and the object voxel is made by binarization processing using the mode method as follows. The plurality of image data actually obtained by CT scanning are luminance data for each X, Y, and Z coordinate. Based on the luminance data, a luminance histogram is generated for all coordinates (all pixels of the plurality of image data). Then, the luminance value of the portion between the two peaks (valleys) appearing in the histogram is set as a threshold value, and the luminance of each coordinate is binarized depending on whether the luminance is larger than or smaller than the threshold value for each coordinate. This distinguishes whether the voxel of each coordinate is a spatial voxel or an object voxel. An example of a state in which spatial voxels and object voxels are distinguished from each other is two-dimensionally illustrated in the middle of FIG. 4. In the lower part of FIG. 4, an enlarged view 64 of a part thereof is two-dimensionally illustrated. Such CT scanning can be performed using, for example, SMX-160CT-SV3 (trade name) manufactured by Shimadzu Corporation. The position of the partition wall 1 where CT scanning is performed is not particularly limited, but is preferably a central part in the extending direction of the cell 2 (the axial direction of the cell 2 described above) of the honeycomb structure 4.

Next, a cross-sectional area S′ of the pores and a wet area A′ of the pores are calculated using the voxel data 60. The cross-sectional area S′ of the pores is an area in which the “spatial voxels” shown in the middle and the lower part of FIG. 4 are present. Therefore, the cross-sectional area S′ of the pores can be calculated as the cross-sectional area S′=the number of spatial voxels×1.2 μm×1.2 μm. The wet area A′ is calculated as the sum of the areas of the interfaces between the spatial voxels and the object voxels in the voxel data 60. More specifically, the wet area A′ is derived as the wet area A′=(the number of interfaces in the voxel data 60)×(the area of one interface). The area of one interface is 1.44 μm² (=1.2 μm×1.2 μm). For example, there are six interfaces between the spatial voxels and the object voxels in the enlarged view 64 shown in the lower part of FIG. 4, so that the sum of the areas of the interfaces in the enlarged view 64 is 6×1.44=8.64 μm². In this way, the wet area A′ is calculated. In the above explanation, the unit of the cross-sectional area S′ of the pores and the wet area A′ of the pores is described as “μm²”, but the unit such as the size (length) of the voxel data 60 can be converted by “m” as appropriate to obtain the wet area A (m²) of the pores and the cross-sectional area S (m²) of the pores. Then, a partition wall wet area ratio (A/S) is calculated based on the cross-sectional area S and the wet area A of the pores.

In the honeycomb filter 100, when the partition wall wet area ratio (A/S) is less than 0.21 m²/m², a surface area to which the catalyst is applied in the partition wall 1 (that is, the wet area in the partition wall 1) is reduced. Therefore, when the catalyst layer is provided in the honeycomb filter 100, the frequency of contact between exhaust gas and the catalyst is difficult to be increased, and an adequate improvement in purification performance cannot be expected. On the other hand, when the partition wall wet area ratio (A/S) exceeds 0.35 m²/m², pressure loss may increase after the catalyst is applied, which is not preferable. The partition wall wet area ratio (A/S) may be 0.21 to 0.35 m²/m², but is preferably, for example, 0.23 to 0.30 m²/m², more preferably 0.25 to 0.27 m²/m².

Further, in the honeycomb filter 100, a pore diameter D10 at which the cumulative pore volume is 10% of the total pore volume is preferably 5.5 to 7.5 μm in the pore diameter distribution of the partition wall 1 described above. Hereinafter, the pore diameter D10 in which the cumulative pore volume is 10% of the total pore volume may be simply referred to as “D10” in the pore diameter distribution of the partition wall 1. When D10 is 5.5 to 7.5 μm, it is preferable in that an increase in pressure loss after the catalyst is applied can be suppressed. Although not particularly limited, D10 is more preferably 6.0 to 7.0 μm.

Further, in the honeycomb filter 100, a pore diameter D90 at which the cumulative pore volume is 90% of the total pore volume is preferably 35.0 μm or less in the pore diameter distribution of the partition wall 1. Hereinafter, the pore diameter D90 in which the cumulative pore volume is 90% of the total pore volume may be simply referred to as “D90” in the pore diameter distribution of the partition wall 1. When D90 is 35.0 μm or less, it is preferable in that the trapping performance can be exhibited satisfactory. Although not particularly limited, D90 is more preferably 27.0 to 35.0 μm, and particularly preferably 27.0 to 32.0 μm.

The shape of the cells 2 defined by the partition wall 1 is not particularly limited. For example, the shapes of the cells 2 in the section that is orthogonal to the extending direction of the cells 2 may be polygonal, circular, elliptical or the like. Examples of the polygonal shape include a triangle, a quadrangle, a pentagon, a hexagon, and an octagon. The shape of the cells 2 is preferably triangular, quadrangular, pentagonal, hexagonal or octagonal. Further, regarding the shapes of the cells 2, all the cells 2 may have the same shape or different shapes. For example, although not shown, quadrangular cells and octagonal cells may be combined. Further, regarding the sizes of the cells 2, all the cells 2 may have the same size or different sizes. For example, although not shown, some of the plurality of cells may be larger, and other cells may be smaller relatively. In the present invention, a cell means a space surrounded by a partition wall.

The shape of the honeycomb structure 4 is not particularly limited. The shape of the honeycomb structure 4 may be a pillar-shape in which the shape of the inflow end face 11 and the shape of the outflow end face 12 includes a circular shape, an elliptical shape, a polygonal shape, or the like.

The size of the honeycomb structure 4, for example, the length from the inflow end face 11 to the outflow end face 12, and the size of a section orthogonal to the extending direction of the cells 2 of the honeycomb structure 4, is not particularly limited. Each size may be selected as appropriate so as to obtain optimum purification performance when the honeycomb filter 100 is used as a filter for purifying exhaust gas.

The material of the partition wall 1 constituting the honeycomb structure 4 is not particularly limited. For example, the material of the partition wall 1 preferably contains at least one selected from the group consisting of cordierite, silicon carbide, silicon-silicon carbide composite material, cordierite-silicon carbide composite material, silicon nitride, mullite, alumina, and aluminium titanate. In the honeycomb filter 100 of the present embodiment, a material containing at least one of cordierite, silicon carbide, and aluminium titanate as the material of the partition wall 1 can be exemplified as a preferable example.

The material of the plugging portion 5 is also not limited especially. For example, the material similar to the material of the partition wall 1 described above may be used.

In the honeycomb filter 100, the partition wall 1 defining a plurality of cells 2 is preferably loaded with a catalyst for purifying exhaust gas. The “partition wall 1 is loaded with a catalyst” means that the catalyst is coated on the surface of the partition wall 1 and the inner wall of the pore formed on the partition wall 1. With this configuration, CO, NOx, HC and the like in exhaust gas can be converted into harmless substrances by a catalytic reaction. In addition, the oxidation of PM such as soot trapped can be accelerated.

The catalyst loaded on the partition wall 1 is not particularly limited. For example, such catalysts may include a catalyst containing a platinum group element and containing an oxide of at least one element among aluminum, zirconium, and cerium.

### (2) Manufacturing Method of Honeycomb Filter

The manufacturing method of the honeycomb filter of the present invention is not particularly limited, and the honeycomb filter can be manufactured by the following method, for example. First, a plastic kneaded material for making a honeycomb structure is prepared. The kneaded material for making a honeycomb structure can be prepared by adding an additive such as a binder, pore former, and water, as appropriate, to a material selected from the above-described suitable materials of the partition wall as a raw material powder. In manufacturing the honeycomb filter of the present invention, as the raw material powder for preparing the kneaded material, for example, kaolin, talc, alumina, aluminium hydroxide, silica, or the like, are used, and the kneaded material can be prepared by making these raw material powders have a chemical composition of 42 to 56% by mass of silica, 30 to 45% by mass of alumina, and 12 to 16% by mass of magnesia. The use of kaolin, alumina, and aluminium hydroxide having an average particle diameter of 7 μm or less can increase small pores in the substrate and increase the partition wall wet area.

Next, the kneaded material thus obtained is subjected to extrusion to make a pillar-shaped honeycomb formed body having a partition wall defining a plurality of cells and a circumferential wall disposed so as to surround the partition wall. In the extrusion, a die in which a slit having an inverted shape of the honeycomb formed body to be formed is provided on the extruded surface of the kneaded material can be used as a die for extrusion.

The obtained honeycomb formed body is dried, for example, by microwave and hot air, and open end of the cell is plugged with a material similar to the material used for making the honeycomb formed body to form a plugging portion. After forming the plugging portion, the honeycomb formed body may be dried again.

Next, the honeycomb formed body on which the plugging portions have been formed was fired to manufacture a honeycomb filter. The firing temperature and the firing atmosphere differ according to the raw material, and those skilled in the art can select the firing temperature and the firing atmosphere that are the most suitable for the selected material.

### EXAMPLES

The following will describe in more detail the present invention by examples, but the present invention is not at all limited by the examples.

### Example 1

To 100 parts by mass of cordierite forming raw material, 2 parts by mass of pore former, 2 parts by mass of dispersing medium, and 7 parts by mass of an organic binder were added, respectively, and mixed and kneaded to prepare a kneaded material. As the cordierite forming raw material, alumina, aluminum hydroxide, kaolin, talc, and silica were used. As the dispersing medium, water was used. As the organic binder, methylcellulose was used. As the dispersing agent, dextrin was used. The aluminium hydroxide having an average particle diameter of 5 μm was used, and a kneaded material for making a honeycomb structure was prepared.

Next, the obtained kneaded material was molded using an extruder to make a honeycomb formed body. Next, the obtained honeycomb formed body was dried by high frequency dielectric heating, and then further dried using a hot air dryer. The shape of the cells in the honeycomb formed body was quadrangular.

Next, a plugging portion was formed on the dried honeycomb formed body. First, the inflow end face of the honeycomb formed body was masked. Next, the end portion provided with the mask (the end portion on the inflow end face side) was immersed in the plugging slurry, and the plugging slurry was filled into an open end of the cell without the mask (the outflow cell). In this way, a plugging portion was formed on the inflow end face side of the honeycomb formed body. Then, the plugging portion was also formed in the inflow cell in the same manner for the outflow end face of the dried honeycomb formed body.

Next, the honeycomb formed body on which the plugging portions have been formed was dried with a microwave dryer and completely dried with a hot air dryer, and then both end faces of the honeycomb formed body were cut and adjusted to a predetermined size. The dried honeycomb formed body was then degreased and fired to manufacture a honeycomb filter of Example 1.

The honeycomb filter of Example 1 had a diameter of the end face of 132.6 mm and a length in the extending direction of the cells of 127.3 mm. The thickness of the partition wall was 210.8 μm and a cell density was 46.8 cells/cm². The thickness of the partition wall is shown in Tables 1.

For the honeycomb filter of Example 1, the “porosity (%)”, “D50 (μm)”, “D10 (μm)” and “D90 (μm)” of the partition wall were measured in the following manner. In addition, the “partition wall wet area ratio” of the partition wall was determined in the following manner. The results are shown in Table 1.

[Porosity (%), D50 (μm), D10 (μm) and D90 (μm)]

The porosity (%), D50 (μm), D10 (μm) and D90 (μm) of the partition wall were measured using Autopore 9500 (trade name) manufactured by Micromeritics. Respective values of D50 (μm), D10 (μm) and D90 (μm) were determined by ascertaining the respective pore diameters (μm) in which the cumulative pore volume in the pore diameter distribution of the partition wall was 50%, 10% and 90% of the total pore volume. In these measurements, a part of the partition wall was cut out from the honeycomb filter to obtain a test piece, and the obtained test piece was used for the measurement. The test piece was a rectangular parallelepiped having a length, a width, and a height of approximately 10 mm, approximately 10 mm, and approximately 20 mm, respectively. The sampling location of the test piece was set in the vicinity of the center of the honeycomb structure in the axial direction.

### [Partition Wall Wet Area Ratio]

The three-dimensional voxel data 60 as shown in FIG. 4 was obtained by performing CT scanning on the partition wall of the honeycomb structure using the method explained above. The obtained three-dimensional voxel data 60 was then used to calculate a partition wall wet area ratio according to the method described above.

TABLE 1

| | | | Comparative | | | | |
|---|---|---|---|---|---|---|---|
| | | | Example 1 | Example 1 | Example 2 | Example 3 | Example 4 |
| Partition | Partition wall | (μm) | 215.9 | 210.8 | 210.8 | 203.2 | 218.4 |
| wall | Thickness | | | | | | |
| properties | Cell density | (cells/cm²) | 47.4 | 46.8 | 47.3 | 48.2 | 48.2 |
| | Porosity | (%) | 61.2 | 65.1 | 65.3 | 65.1 | 63 |
| | D50 | (μm) | 14.3 | 12.4 | 12.2 | 12.4 | 14.2 |
| | D10 | (μm) | 8.7 | 6.5 | 6.2 | 6.5 | 6.5 |
| | D90 | (μm) | 27.7 | 28.2 | 27.9 | 35.2 | 27.5 |
| | Partition wall | (m²/m²) | 0.20 | 0.25 | 0.27 | 0.25 | 0.30 |
| | wet area ratio | | | | | | |
| Judgment | Pressure loss | | — | Good | Good | Good | Good |
| | Purification | | — | Good | Good | Good | Excellent |
| | Performance | | | | | | |
| | Trapping | | Good | Good | Good | Acceptable | Good |
| | Performance | | | | | | |

The honeycomb filter of Example 1 was evaluated for pressure loss, purification performance, and trapping performance in the following manner. The results are shown in Table 1.

### (Pressure Loss)

A gas at 25° C. was flowed in at a flow rate of 10 Nm³/minute using a large wind tunnel tester to measure the pressure on the inflow end face side and the outflow end face side of the honeycomb filter. Then, the pressure loss (kPa) of the honeycomb filter was determined by calculating the pressure difference between the inflow end face side and the outflow end face side. Then, the rate of increase (%) in pressure loss of the honeycomb filter of each example with respect to the value of the pressure loss of the honeycomb filter of Comparative Example 1 was determined. In the evaluation of the pressure loss, the honeycomb filter of each example was evaluated based on the following evaluation criteria.

Evaluation “Good”: When the rate of increase (%) in pressure loss is less than 10%, the evaluation is regarded as “Good”.

Evaluation “Not acceptable”: When the rate of increase (%) in pressure loss is 10% or more, the evaluation is regarded as “Not acceptable”.

### (Purification Performance)

The honeycomb filter loaded with 100 g/L of three-way catalyst was mounted on the underfloor position of a vehicle with a displacement of 1500 cc, and the bench test in the running mode RTS95 cycle was performed to determine NOx purification rate (%) of the honeycomb filter. Then, the purification performance was evaluated by comparing NOx purification rate (%) of the honeycomb filter of each example with respect to the value of NOx purification rate (%) of the honeycomb filter of Comparative Example 1. Specifically, in the evaluation of the purification performance, the honeycomb filter of each example was evaluated based on the following evaluation criteria.

Evaluation “Excellent”: When the NOx purification rate (%) is improved by 1.0% or more with respect to the value of the NOx purification rate (%) of the honeycomb filter of Comparative Example 1, the evaluation is regarded as “Excellent”.

Evaluation “Good”: When the NOx purification rate (%) is improved by 0.5% or more and less than 1.0% with respect to the value of the NOx purification rate (%) of the honeycomb filter of Comparative Example 1, the evaluation is regarded as “Good”.

Evaluation “Not acceptable”: When the NOx purification rate (%) is improved by less than 0.5% with respect to the value of the NOx purification rate (%) of the honeycomb filter of Comparative Example 1, the evaluation is regarded as “Not acceptable”.

### (Trapping Performance)

The honeycomb filter was mounted on the underfloor position of a vehicle with a displacement of 1500 cc, and a bench test in the running mode RTS95 cycle was performed. Exhaust gas containing PM was flowed in the honeycomb filter. At this time, the trapping efficiency (%) of the honeycomb filter was determined by measuring the number of PM in the exhaust gas prior to flowing into the honeycomb filter and the number of PM in the exhaust gas flowing out of the honeycomb filter. In the evaluation of the trapping performance, the honeycomb filters of the respective examples were evaluated based on the following evaluation criteria.

Evaluation “Good”: When the trapping efficiency (%) is 70% or more, the evaluation is regarded as “Good”.

Evaluation “Acceptable”: When the trapping efficiency (%) is 65% or more and less than 70%, the evaluation is regarded as “Acceptable”.

Evaluation “Not acceptable”: When the trapping efficiency (%) is less than 65%, the evaluation is regarded as “Not acceptable”.

### Examples 2 to 4

In Examples 2 to 4, the configuration of the honeycomb structure was changed as shown in “Partition wall properties” in Table 1. In Examples 2 and 4, the honeycomb structure was prepared by reducing the particle diameter of pore former added to the raw material powder. In Example 3, the honeycomb structure was prepared by increasing the particle diameter of pore former added to the raw material powder.

### Comparative Example 1

In Comparative Example 1, the configuration of the honeycomb structure was changed as shown in “Partition wall properties” in Table 1. In Comparative Example 1, the particle diameter of pore former and the added amount of the same were adjusted to prepare the honeycomb structure in which the small pore volume was reduced.

The honeycomb filters of Examples 2 to 4 were also evaluated for pressure loss, purification performance, and trapping performance in the same manner as in Example 1. The results are shown in Table 1. The honeycomb filter of Comparative Example 1 serves as an evaluation criterion in evaluating pressure loss and purification performance.

### (Results)

The honeycomb filters of Examples 1 to 4 were superior to the honeycomb filter of Comparative Example 1 as an evaluation criterion in evaluating pressure loss and purification performance. In particular, the honeycomb filter of Example 4 had a partition wall wet area of 0.03 m²/m², and was particularly excellent in evaluating purification performance. The honeycomb filters of Examples 1 and 3 showed comparable partition wall wet area ratios. However, the honeycomb filter of Example 1 showed better trapping performance when the detailed trapping performance was compared. It is presumed that the honeycomb filter of Example 1 is smaller in the value of D90 than the honeycomb filter of Example 3, so that trapping performance is improved.

### INDUSTRIAL APPLICABILITY

The honeycomb filter of the present invention can be used as a filter to trap particulate matter in exhaust gas.

### DESCRIPTION OF REFERENCE NUMERALS

1: partition wall, 2: cell, 2a: inflow cell, 2b: outflow cell, 3: circumferential wall, 4: honeycomb structure, 5: plugging portion, 11: inflow end face, 12: outflow end face, 60: voxel data, 64: enlarged view, 100: honeycomb filter.

1. A honeycomb filter comprising: a pillar-shaped honeycomb structure having a porous partition wall disposed so as to surround a plurality of cells which serve as a fluid through channel extending from an inflow end face to an outflow end face; and
a plugging portion provided at either an end on the inflow end face side or an end on the outflow end face side of the cell; wherein
a thickness of the partition wall is 152 to 254 μm,
a cell density of the honeycomb structure is 38.8 to 62.0 cells/cm²,
a pore diameter D50 at which the cumulative pore volume is 50% of the total pore volume is 11 to 15 μm in a pore diameter distribution of the partition wall measured by the mercury press-in method,
a porosity of the partition wall measured by the mercury press-in method is 60 to 75%, and
a partition wall wet area ratio (A/S), which is a value obtained by dividing a wet area A of pores formed in the porous partition wall by a cross-sectional area S of the pores, is 0.21 to 0.35 m²/m².

2. The honeycomb filter according to claim 1, wherein a pore diameter D10 at which the cumulative pore volume is 10% of the total pore volume is 5.5 to 7.5 μm in the pore diameter distribution of the partition wall measured by the mercury press-in method.

3. The honeycomb filter according to claim 1, wherein a pore diameter D90 at which the cumulative pore volume is 90% of the total pore volume is 35.0 μm or less in the pore diameter distribution of the partition wall measured by the mercury press-in method.
